(19) United States
(12) Patent Application Publication
(10) Pub. No.: US 2026/0110403 A1
(43) Pub. Date: Apr. 23, 2026

(54) HIGH TEMPERATURE REUSABLE VACUUM-JACKETED INSULATION FOR ROCKET MISSIONS

(71) Applicant: Blue Origin, LLC, Kent, WA (US)

(72) Inventors: Nico Schwartz, Cocoa, FL (US); John Paul Brendel, Coeur D’Alene, ID (US)

(21) Appl. No.: 18/918,601

(22) Filed: Oct. 17, 2024

(51) Int. Cl. F17C 13/00

(52) U.S. Cl. CPC F17C 13/001; F17C 2203/0325; F17C 2203/035; F17C 2203/0391; F17C 2270/0197

(57) ABSTRACT

A number of techniques, structures, and materials for thermally insulating a cryogenic propellant tank barrel section are presented. Thermal insulation for a tank, such as tanks for use in space flight missions, may be a dual wall vacuum jacket system where one wall is the propellant tank wall and the other wall is a metallic foil that is welded to portions of the propellant tank wall. The metallic foil may act as a vapor barrier and a vacuum seal. A structural and breathable insulation that is durable and functional in a range from cold to relatively high temperatures may be used to maintain a standoff distance between the two walls. The volume between the propellant tank wall and the metallic foil may be purged with a gas that has a liquefaction temperature greater than that of the cryogenic propellant that will be in the propellant tank during operations.

### BACKGROUND

In space, long duration missions generally require a capability to store and maintain propellant throughout the mission. Cryogenic propellants, such as liquid oxygen and liquid hydrogen, are difficult to maintain due to heating in space, which causes these propellants to boil off. Moreover, storage tanks of such liquids may be subjected to extreme heat during a reentry phase of a mission. Thus, such storage tanks may be insulated by a thermal protection system (TPS) to protect their contents from heat transfer into and out of the tanks.

In addition to storage tanks, space vehicles may also use a TPS to inhibit the conduction of heat to the interior of the vehicle. For example, a TPS may include various materials applied externally to the outer structural skin of a space vehicle to maintain acceptable temperatures during reentry and other phases of flight. Materials used for a TPS are generally selected for their high-temperature stability and weight efficiency.

There is a general tradeoff between weight and mass of insulation and the insulative value that it provides. There continues to be a demand for insulating techniques and materials that can be used for space flight missions and can withstand the high temperatures of reentry, for which relatively light weight and low mass (and sufficient strength) are very important design considerations.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a perspective view of an insulated cryogenic tank separated from a rocket and in an atmospheric reentry, according to some embodiments.

FIG. 2 is a cross-section view of a partially insulated cryogenic tank of a rocket, according to some embodiments.

FIG. 3 is a close-up cross-section view of the wall of an insulated cryogenic tank, according to some embodiments.

FIG. 4 is a close-up cross-section view of the wall of a cryogenic tank with an overlying insulation system, according to some embodiments.

FIG. 5 is a close-up cross-section view of the wall of a cryogenic tank with an overlying insulation system that is covered by a thermal protection system, according to some embodiments.

FIG. 6 is a flow diagram of a process for operating a reusable, high-temperature cryogenic insulation system for a cryogenic tank of a rocket, according to some embodiments.

### DETAILED DESCRIPTION

This disclosure describes a number of techniques, structures, and materials for insulating a cryogenic propellant tank barrel section. For example, in some implementations, the insulation is a dual wall vacuum jacket system where one wall is the propellant tank wall and the other wall is a metallic foil that is brazed or welded to the propellant tank. The metallic foil may act as a vapor barrier and a vacuum seal. A structural and breathable insulation that is durable, compressible, and functional in a range from cold to relatively high temperatures may be used to maintain a standoff distance between the two walls. The volume (e.g., cavity) between the propellant tank wall and the metallic foil may be purged with a gas that has a liquefaction temperature that is greater than that of the cryogenic propellant that will be in the propellant tank during operations.

As described in detail below, a cryogenic propellant tank may hold rocket propellant such as liquid hydrogen (LH2) and liquid oxygen (LO2). Such a tank may be used, for example, in a second stage of a rocket launch of a space vehicle. In this case, after its use as a second stage, the tank may be separated from the space vehicle and guided into a course for reentry to Earth. The separation may occur in a lower Earth orbit, for example. The tank may include thrusters, propellant, and aerodynamic features (e.g., fins, wings, etc.) so that its reentry and return to Earth's surface may include controlled flight. Accordingly, some portions of the tank surface will experience much greater temperatures during reentry as compared to other portions. For example, during reentry, a front-bottom surface portion of the tank may face head-on into the atmosphere at very high speeds and thus become extremely hot. In contrast, a top-rear leeward surface may not have such exposure and will likely be much cooler.

In some embodiments, the reusable, high-temperature cryogenic (vacuum-jacketed) insulation system for a cryogenic tank structure may include a tank shell having an interior surface and an exterior surface, a metallic foil covering at least a portion of the exterior surface of the tank shell, and a gas-permeable thermal insulation (e.g., a fiberglass mat) occupying a volume, herein referred to as a cavity, between the exterior surface of the tank shell and the metallic foil. During some parts of the insulation system's operation, a gas in the cavity may permeate the gas-permeable thermal insulation. The gas may condense, via thermal conduction, when cryogenic fluid is in the cryogenic tank. This condensation may resultantly create a vacuum in the cavity and may also decrease the thermal insulation (and cavity) thickness, depending on a pressure on the exterior side of the metallic foil. In some implementations, the fiberglass matt may be incompressible, wherein a reduction in its thickness may not be necessary.

The metallic foil may have a resilience, and thus a freedom to billow outward or pull inward, for example, that allows for the expansion or compression of the thermal insulation between the exterior surface of the tank shell and the metallic foil based on a pressure difference across the metallic foil. This pressure difference may depend, at least in part, on a state of the gas in the cavity and the pressure outside the cavity. For example, when the gas is condensed to a liquid or solid, its pressure may be substantially zero and a vacuum is resultantly created in the cavity. For example, at liquid hydrogen temperatures, nitrogen can fully solidify. A vacuum can still be maintained at slightly higher temperatures. Nitrogen liquifying before hydrogen (in terms of decreasing temperature) may potentially be beneficial by allowing the nitrogen to drain away from the insulation.

A valve may control flow of the gas in and out of the cavity. In some implementations, a control system may be configured to operate the valve to maintain the pressure of the gas to be substantially a vacuum for i) a launch pad hold and launch stage, ii) an orbital coast stage, and iii) a reentry stage. In some implementations, a control system may be configured to operate the valve to purge the cavity between the exterior surface of the tank shell and the metallic foil with a cooling fluid, such as nitrogen or another gas, before the tanks are filled with a cryogenic liquid. This (fluid (e.g., gas) would be what condenses to form the vacuum. The vacuum can be entirely formed by the condensation of gas or also by a pump pulling a vacuum to aid in the creation of the vacuum. A venturi pump could use boiloff of the tanks to pull a vacuum passively, for example.

As indicated above, the tank shell may be a portion of a fuel system for a secondary stage of a rocket. The tank shell may be configured, via thermal conductivity of the gas-permeable thermal insulation, to be a heat sink for heat generated during a reentry stage of space flight. In some implementations, as explained below, the insulation system may further comprise a thermal protection system (TPS) that at least partially covers the metallic foil, depending on its location on the surface of the tank.

In some embodiments, a method of operating a reusable, high-temperature cryogenic insulation system for a cryogenic tank of a rocket may include providing a gas, such as nitrogen, to a gas-permeable thermal insulation that occupies a cavity between an exterior surface of the cryogenic tank and a metallic foil that overlays the cryogenic tank. The cryogenic tank may at least be partially filled with a cryogenic fluid, and the cold temperature of the cryogenic fluid in the cryogenic tank may be allowed to condense the gas into a liquid so as to create a vacuum in the cavity. The method may also include launching the rocket while the cryogenic fluid in the cavity remains condensed as a liquid and allowing the vacuum in the cavity to equalize with the pressure of the vacuum of space during a subsequent orbital coast phase for the rocket. The equalization may lead to an increase in the cavity thickness (allowing the foil to billow) between the exterior surface of the cryogenic tank and the metallic foil, as explained below. The method may also include maintaining the vacuum in the cavity during a reentry phase for the rocket so that the thickness of the cavity decreases due to atmospheric pressure. This decrease may increase thermal conductivity across the insulation and thus allow the cryogenic tank to be efficiently used as a heat sink during reentry. Having a vacuum during reentry may likely be useful for helping to prevent the foil from getting destroyed during reentry, and in space there may be some benefits of allowing the foil to slightly billow, but an increase in conductivity may be relatively small. Allowing the foil to billow in space and not rest directly on the fiberglass mat may greatly reduce conductivity.

The method may further include operating one or more valves that controls a flow in and out of the cavity to i) allow the cold temperature of the cryogenic fluid in the cryogenic tank to condense the gas in the cavity into the liquid, ii) allow a vacuum in the cavity to equalize with the pressure of the vacuum of space during the orbital coast phase for the rocket, as the tank warms up (e.g., there is boiloff), and iii) maintain the vacuum in the cavity during the reentry phase for the rocket. The valve(s) may also be operated to purge the cavity between the exterior surface of the cryogenic tank and the metallic foil with a cooling fluid, such as after a landing of the cryogenic tank.

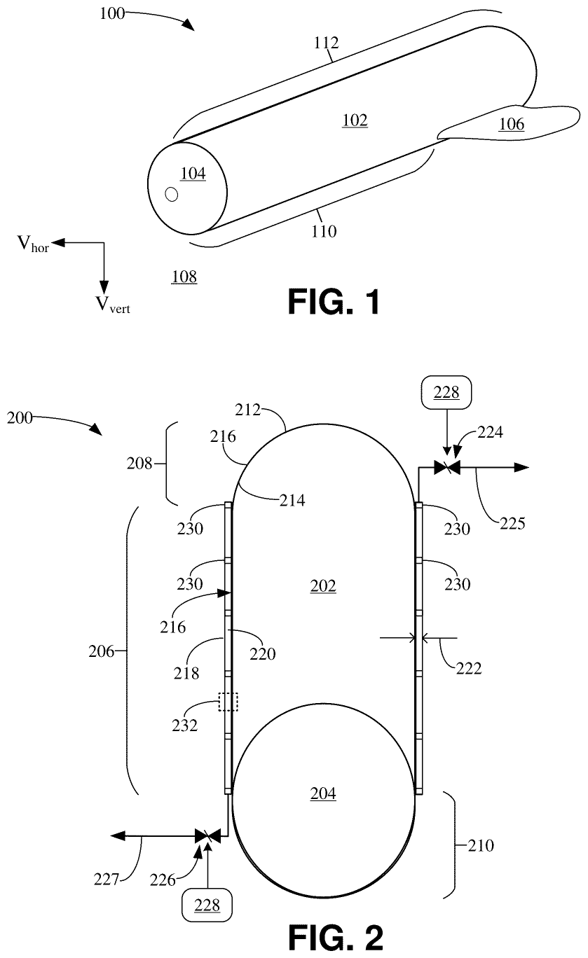

FIG. 1 is a perspective view, which is not necessarily to scale, of an insulated cryogenic tank 100 separated from a rocket and in an atmospheric reentry, according to some embodiments. Tank 100 may include a barrel section 102, a nose portion 104, and one or more fins 106. For example, tank 100 is depicted as being in a controlled reentry flight in an atmosphere 108. The direction (e.g., attitude and orientation) of the tank during reentry may be controlled so that the tank may be landed and reused at the conclusion of the reentry. Tank 100 reenters the Earth's atmosphere with both horizontal and vertical velocity components. Accordingly, particular portions of the tank's surface may face forward into the atmosphere while other surface portions may face away. These respective portions, therefore, may likely require different amounts of thermal protection and insulation. For example, a bottom portion 110, and nose portion 104, may face into the high-speed influx of atmospheric molecules and heat up greatly while a top portion 112 is in a shadow of the incident atmospheric molecules and may thus remain relatively cool (in terms of reentry temperatures). The amount of thermal protection and insulation may vary in accordance with different portions of the tank surface and their expected reentry temperatures.

FIG. 2 is a cross-section view, which is not necessarily to scale, of a partially insulated cryogenic tank 200 of a rocket, according to some embodiments. Tank 200, which may be a portion of a second stage rocket of a space vehicle, may include a tank 202 for containing LH2 and a tank 204 for containing LO2, for instance. Different parts of tank 200 may be covered with different types and/or quantities of thermal insulation or TPS. For example, a barrel section 206 may be covered with the reusable, high-temperature vacuum-jacketed cryogenic insulation system, as described herein, while a nose section 208 and a tail section 210 may include a different type of thermal insulation or TPS. Generally, the “barrel” section of a tank may be considered to be the part of the tank that is cylindrical while the nose and/or tail sections are conical, dome like, or are a shape that “caps off” the ends of the barrel section.

The reusable, high-temperature cryogenic insulation system may include a tank shell 212 having an interior surface 214 and an exterior surface 216, a metallic foil 218 covering at least a portion of exterior surface 216 of tank shell 212, and a gas-permeable thermal insulation 220 occupying a cavity 222 between the exterior surface of the tank shell and the metallic foil. Tank shell 212 may be steel, aluminum, titanium, Inconel®, or aluminum-lithium alloys, just to name a few examples.

During some parts of its operation, the insulation system may include a gas, such as nitrogen, that can permeate the gas-permeable thermal insulation. In some implementations, a first valve 224 may control flow of the gas, via a line 225, in and out of the cavity. In other implementations, first valve 224 may control flow of the gas into the cavity and a second valve 226 may control flow of the gas, via a line 227, out of the cavity. Both first and second valves may be used for purging the cavity. A control system 228 may be configured to operate the one or more valves to adjust or maintain the pressure of the gas in the cavity. For example, the control system may close one or more valves to maintain a vacuum in the cavity while the gas is in a condensed (liquid) form. In some implementations, the control system may maintain a vacuum for i) a launch pad hold and launch stage, ii) an orbital coast stage, and iii) a reentry stage. In some implementations, control system 228 may be configured to operate valves 224 and 226 to purge cavity 222 with a cooling fluid.

As indicated above, the tank shell may be a portion of a fuel system for a secondary stage of a rocket. Tank shell 212 may be configured, via its thermal conductivity and that of the gas-permeable thermal insulation, to be a heat sink for heat generated by the interaction of atmospheric molecules and metallic foil 218 during a reentry stage of space flight. In some implementations, the insulation system may further comprise a TPS that at least partially covers the metallic foil. If so, then reentry heat may be generated by the interaction of atmospheric molecules and the TPS. The heat will then flow to and through the insulation system and into heat-sinking tank 200.

In some implementations, a structure of tank 200 may include circ rings 230 on the exterior perimeter of barrel section 206. Metallic foil 218 may be attached (e.g., via welding) to the circ rings. A portion 232 of the reusable, high-temperature cryogenic insulation system is indicated in the figure and is illustrated in detail and described below. In some implementations, a passive one way valve, which doesn't allow pressure into the cavity but allows it out, may be used. This means that in orbital coast phases any buildup of pressure can escape. Also, during reentry any boiling nitrogen doesn't necessarily create pressure in the cavity but also can escape (though this may be considered to be more of a backup scenario). In a preferred situation, the amount of nitrogen in the cavity may be as low as possible during reentry and is allowed to vent during coasting.

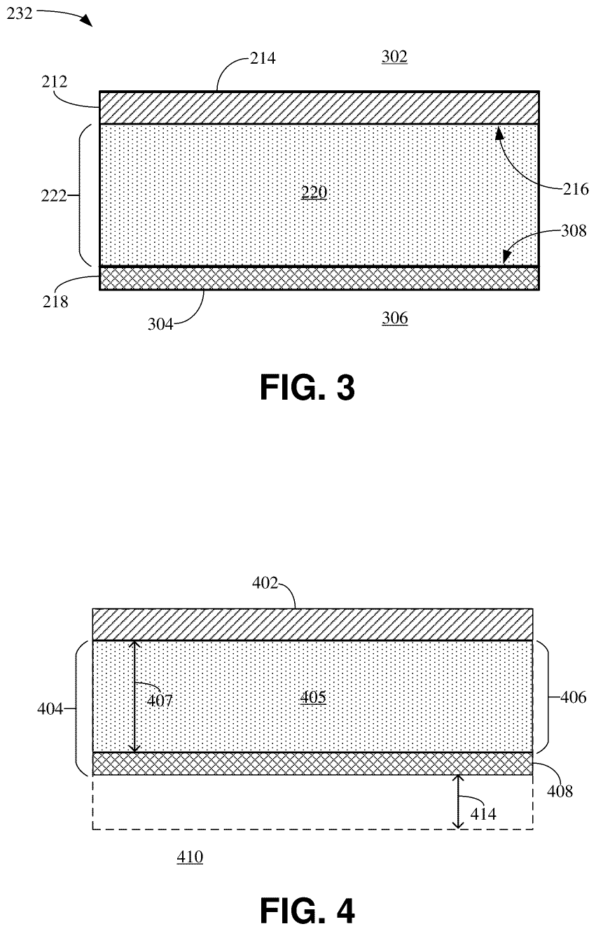

FIG. 3 is a close-up cross-section view, which is not necessarily to scale, of portion 232, from FIG. 2, of tank 200 that is configured to contain a cryogenic fluid 302 (e.g., LH2 or LO2). Portion 232 includes tank shell 212, interior surface 214 of the tank shell, exterior surface 216 of the tank shell, metallic foil 218, and gas-permeable thermal insulation 220 occupying cavity 222 between the exterior surface of the tank shell and the metallic foil. During various parts of a space flight, an exterior surface 304 of metallic foil 218 may be exposed to different ambient pressures 306 outside of the tank, such as Earth's atmosphere or the vacuum of space (e.g., outside Earth's atmosphere). An interior surface 308 of metallic foil 218 may be in contact with gas-permeable thermal insulation 220. As described below, depending on ambient pressure 306 with respect to a pressure in cavity 222, the contact between metallic foil 218 and gas-permeable thermal insulation 220 may be compressive (e.g., the metallic foil pushing against the gas-permeable thermal insulation) or may be relatively neutral, wherein there's no substantial net force between the two materials.

In some implementations, gas-permeable thermal insulation 220 may be a fiberglass mat embedded with silica aerogel. For example, silica aerogel may be embedded in a fibrous matrix, such as fiberglass, to form an aerogel blanket. This process transforms relatively brittle aerogel into a flexible, durable solid that can be used as a compressible thermal insulation. An aerogel blanket has a relatively large surface area and a high porosity that allows a gas to pass into and through it. “Gas-permeable” refers to this property, which may be largely determined by the structure of the insulation. For example, the insulation may comprise interconnected paths and spaces that allow gas to permeate the material.

Generally, gas-permeable thermal insulation 220 in cavity 222 may be in any of three conditions, each of which can occur at different portions of a space vehicle's operations, such as its preparation, launch, flight, reentry, and post-landing. In one condition, the gas-permeable thermal insulation may be in a vacuum maintained in the cavity 222. In another condition, the gas-permeable thermal insulation may be infused with a gas, such as nitrogen. In yet another condition, the gas infused in the gas-permeable thermal insulation may be chilled and condensed to a liquid or solid so that the gas-permeable thermal insulation and liquid are in a vacuum (or partial vacuum), which may be maintained in cavity 222.

FIG. 4 is a close-up cross-section view, which is not necessarily to scale, of the wall 402 of a cryogenic tank with an overlying insulation system 404. A gas-permeable thermal insulation 405 occupies a cavity 406. The figure depicts the case when the cavity, which has a thickness equal to a distance of separation 407 between the tank and a metallic foil 408, is holding a vacuum or at least has a pressure that is less than an ambient pressure 410 outside the tank and insulation system. Gas-permeable thermal insulation 405 may be compressed due to a difference in the pressure in cavity 406 and the pressure outside (e.g., 410) the cavity. The insulation is compressed from its natural (e.g., with no applied external forces of compression) thickness by a distance 414. Generally, all other things being equal, the thicker the insulation, the longer the heat conducting path, and the better the insulator for resisting heat transfer. Accordingly, uncompressed thermal insulation 405, having a thickness equal to separation 407 plus distance 414, is a better insulator than compressed thermal insulation 405, having a thickness equal to separation 406. And in contrast, compressed thermal insulation 405 is a better conductor of heat, which may allow for efficient heat transfer for when the tank is used as a heat sink during reentry.

As discussed above, a gas-permeable thermal insulation in a cavity may be in any of three conditions, each of which can occur at different portions of a space vehicle's operations, such as its preparation and launch, flight, reentry, and post-landing. For example, during preparation, tanking of cryogenic propellant, gas inside cavity 406 may condense due to the presence of the cold propellant on just the other side of the tank wall. This condensation may create a hard vacuum in the cavity so that convective heat transfer cannot occur. Herein, hard vacuum may be considered to be 10\hat{ }−5 Torr or less pressure. In some implementations, this process may be assisted by use of a vacuum pump to reduce the volume of condensed-liquid pooling in the insulation. Such a vacuum pump may be an active electrical vacuum pump or a passive vacuum pump that relies on propellant boiloff through a venturi, for example.

Accordingly, during tanking, pad hold, and launch, the insulation acts as an effective cryogenic insulation that reduces boiloff and helps to prevent liquid air and ice formation on the space vehicle's OML (outer mold line). Liquid air formation is generally a hazard for propellant tanks that store LH2.

During orbital coast phases, the vacuum inside and outside metallic foil 408 may equalize to allow the metallic foil to billow slightly. This consequently reduces conductivity across insulation system 404.

During reentry, insulation system 404 acts as a TPS that is capable of high temperature operation, such as over 1500 degrees F. (Fahrenheit), for example. This high temperature capability allows the tank's thermal mass to absorb heat. In other words, the cryogenic tank may be used as a heat sink, particularly if the tank utilizes high temperature-capable alloys. Gas may be evacuated from cavity 406 during this phase of flight to maintain a low pressure (e.g., vacuum) as the thermal insulation heats up from reentry. Once landed, the cavity may be purged to aid cooling, if desired.

In a particular non-limiting example, the cryogenic tank may be a stainless steel or Inconel® propellant tank that is insulated with overlying insulation system 404 for the barrel section of the tank. The inside boundary of insulation system 404 is the structural wall 402 of the tank, which is configured to contain propellant at cryogenic temperatures. The outer boundary of insulation system 404 is a relatively thin 625 Full Hard Inconel foil 0.001″ that may be resistance seam welded to the tank wall or to external tank circ rings (e.g., 230). Full hard Inconel foil is generally highly damage tolerant and will resist damage from rain erosion or exposure to the elements on the launch pad. (ESD coating may not be necessary due to the material's electrical conductivity.) (Thickness of foil may correspond to lightning strike survivability.) The inner surface (e.g., facing inward toward the center of the tank) of this metal foil may be coated with copper, for example, to reduce its emissivity.

A fiberglass mat embedded with silica aerogel may be used for thermal insulation 405 and to create a standoff that maintains the cavity. This cavity between the outer and inner boundaries of insulation system 404 may be purged with nitrogen which, during tanking of LH2 (e.g., liquefaction temperature is −423 degrees F.) may condense the nitrogen (e.g., liquefaction temp is −320 degrees F.), thus creating a hard vacuum. This process may be assisted by use of a venturi vacuum pump operated by the LH2 boiloff through the pump during the fill and storage operations for the tank. During pad hold and launch, the insulation may act as a cryogenic insulation that reduces boiloff and prevents liquid air and ice formation on the vehicle OML.

During orbital coast phases, the vacuum inside and outside the cavity may equalize with the vacuum of space and the metal foil (e.g., 408) may billow slightly, leading to the metal foil acting as an MLI (multilayer insulation). In some implementations, additional layers of MLI may be added inside the insulation system to potentially improve the emissivity of internal surface, for example.

During reentry, insulation system 404 may act as a TPS that is capable of high temperature operation, considering that the metal foil may be made of hardened Inconel 625, which can withstand elevated temperatures over 1500 degrees F. The tank's thermal mass may be used to absorb heat and, in some implementations, may be allowed to go to its maximum operating temperature in a hot tank design.

After reentry and landing, thermal insulation 405 may be purged to facilitate cooling. For inspection, the cavity may be evacuated and the resulting vacuum may be used to conduct a leak test. Leaks may be patched with a resistance welder. The cavity may subsequently be purged with CO2 or Nitrogen.

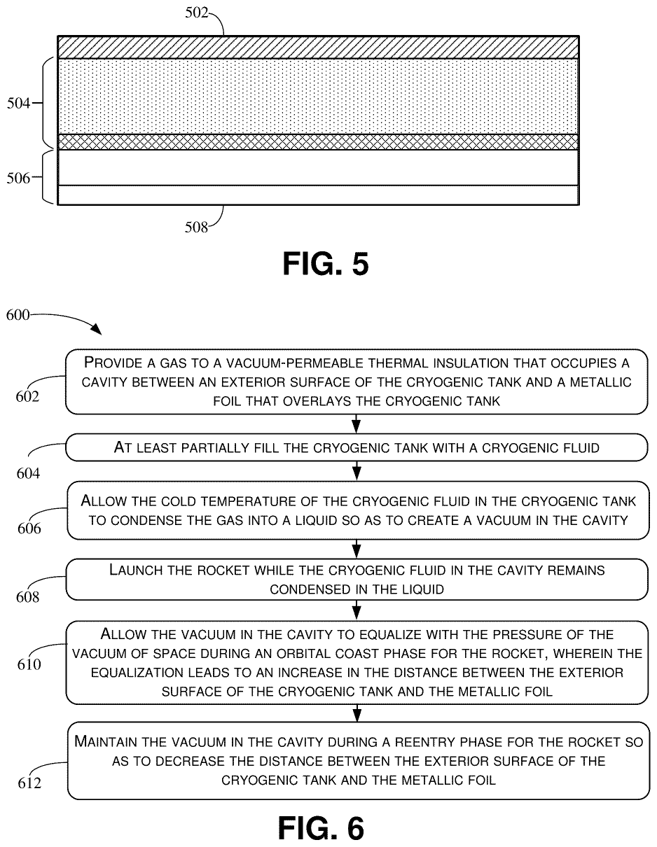

FIG. 5 is a close-up cross-section view, which is not necessarily to scale, of the wall 502 of a cryogenic tank with an overlying thermal insulation system 504 that is covered by a TPS 506, according to some embodiments. For example, wall 502 and system 504 may be the same as or similar to wall 402 with overlying insulation system 404. TPS 506, which may include a number of layers and materials (e.g., spray-on foam insulation (SOFI), low density ceramic or glass-based tiles, rigidized carbon felt, Saffil® blanket material, etc.), has an exterior surface 508 that, depending on its location on a space vehicle, may encounter high speed atmospheric molecules during a reentry. As mentioned above, the amount of thermal protection and insulation may vary in accordance with different portions of the tank surface and the expected reentry temperatures of those portions. For example, referring to FIG. 1, TPS 506 may cover insulation system 504 on bottom portion 110, which may likely heat up greatly during reentry. In contrast, TPS 506 need not cover insulation system 504 on top portion 112, which may be shadowed from the incident atmospheric molecules during reentry.

FIG. 6 is a flow diagram of a process 600 for operating a reusable, high-temperature cryogenic insulation system for a cryogenic tank of a rocket, according to some embodiments. For example, the process may be performed by an operator such as a crew member, an electronic controller, a computer processing system following computer-executable instructions, or a combination thereof. At 602, the operator may provide a gas, such as nitrogen, to a gas-permeable thermal insulation that occupies a cavity between an exterior surface of the cryogenic tank and a metallic foil that overlays the cryogenic tank. At 604, the operator may at least partially fill the cryogenic tank with a cryogenic fluid, such as LH2. At 606, the operator may allow the cold temperature of the cryogenic fluid in the cryogenic tank to condense the gas into a liquid so as to create a vacuum or at least reduce the pressure of the gas in the cavity. At 608, the operator may launch the rocket while the cryogenic fluid in the cavity remains condensed into a liquid. At 610, the operator may allow the vacuum in the cavity to equalize with the pressure of the vacuum of space during an orbital coast phase for the rocket. This equalization leads to an increase in the distance between the exterior surface of the cryogenic tank and the metallic foil and a concomitant increase in the thickness of the (compressible and expandable) gas-permeable thermal insulation. At 612, the operator may maintain the vacuum in the cavity during a reentry phase for the rocket so as to decrease the distance between the exterior surface of the cryogenic tank and the metallic foil and a concomitant increase in rigidity of the metallic foil over the gas-permeable thermal insulation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A reusable, high-temperature cryogenic insulation system for a cryogenic tank, the system comprising:
a tank shell having an interior surface and an exterior surface, wherein the interior surface is configured to contain a cryogenic fluid;
a metallic foil covering at least a portion of the exterior surface of the tank shell;
a gas-permeable thermal insulation occupying a cavity between the exterior surface of the tank shell and the metallic foil;
a gas in the cavity that condenses, via thermal conduction, when the cryogenic fluid is in the cryogenic tank and resultantly creates a vacuum or a reduced pressure in the cavity, wherein the metallic foil has a resilience that allows for a distance between the exterior surface of the tank shell and the metallic foil to change based on the reduced pressure of the gas in the cavity.

2. The system of claim 1, further comprising a valve configured to control flow of the gas in and out of the cavity.

3. The system of claim 2, wherein the reduced pressure of the gas is based, at least in part, on the flow of the gas and a temperature of the gas.

4. The system of claim 2, further comprising a control system configured to operate the valve to maintain a pressure of the gas to be at substantially a vacuum for i) a launch pad hold and launch stage, ii) an orbital coast stage, and iii) a reentry stage.

5. The system of claim 2, further comprising a control system configured to operate the valve to purge the cavity between the exterior surface of the tank shell and the metallic foil with a cooling fluid.

6. The system of claim 1, wherein the distance between the exterior surface of the tank shell and the metallic foil is further based on a pressure of the gas relative to pressure exerted on the metallic foil from outside the system.

7. The system of claim 1, wherein the distance between the exterior surface of the tank shell and the metallic foil is further based, at least in part, on a presence of the cryogenic fluid within the interior surface of the tank shell.

8. The system of claim 1, wherein the tank shell is a portion of a fuel system for a secondary stage of a rocket.

9. The system of claim 1, wherein the gas-permeable thermal insulation comprises a fiberglass mat embedded with a silica aerogel.

10. The system of claim 1, wherein the metallic foil has a thickness of less than about 0.05 inches to provide for the resilience.

11. The system of claim 1, further comprising a thermal protection system (TPS) at least partially covering the metallic foil.

12. The system of claim 1, wherein the tank shell is configured, via thermal conductivity of the gas-permeable thermal insulation when the cavity is in the vacuum or the reduced pressure, to be a heat sink for heat generated during a reentry stage of space flight.

13. A method of operating a reusable, high-temperature cryogenic insulation system for a cryogenic tank of a rocket, the method comprising:
providing a gas to a gas-permeable thermal insulation that occupies a cavity between an exterior surface of the cryogenic tank and a metallic foil that overlays the cryogenic tank;
at least partially filling the cryogenic tank with a cryogenic fluid;
allowing the cold temperature of the cryogenic fluid in the cryogenic tank to condense the gas into a liquid so as to create a vacuum or a reduced pressure in the cavity;
launching the rocket while the cryogenic fluid in the cavity remains condensed in the liquid;
allowing the vacuum or the reduced pressure in the cavity to equalize with the pressure of the vacuum of space during an orbital coast phase for the rocket, wherein the equalization leads to an increase in a distance between the exterior surface of the cryogenic tank and the metallic foil; and
maintaining the vacuum or the reduced pressure in the cavity during a reentry phase for the rocket so as to decrease the distance between the exterior surface of the cryogenic tank and the metallic foil.

14. The method of claim 13, further comprising operating a valve that controls a flow in and out of the cavity to i) allow the cold temperature of the cryogenic fluid in the cryogenic tank to condense the gas into the liquid, ii) allow the vacuum or the reduced pressure in the cavity to equalize with the pressure of the vacuum of space during the orbital coast phase for the rocket, and iii) maintain the vacuum or the reduced pressure in the cavity during the reentry phase for the rocket.

15. The method of claim 14, further comprising operating the valve to purge the cavity between the exterior surface of the cryogenic tank and the metallic foil with a cooling fluid.

16. The method of claim 13, further comprising operating the cryogenic tank as a heat sink for heat generated during the reentry phase.

17. The method of claim 13, wherein the cryogenic tank is a portion of a fuel system for a secondary stage of the rocket.

18. The method of claim 13, wherein the gas-permeable thermal insulation comprises a fiberglass mat embedded with silica aerogel.

19. The method of claim 13, wherein the metallic foil has a thickness of less than about 0.05 inches to provide the metallic foil with resilience that allows the metallic foil to billow out and increase the distance between the exterior surface of the cryogenic tank and the metallic foil.

20. The method of claim 13, wherein the gas has a condensation temperature that is greater than the condensation temperature of the cryogenic fluid.
